(19) United States
(12) Patent Application Publication
(10) Pub. No.: US 2008/0145576 A1
(43) Pub. Date: Jun. 19, 2008

(54) Food casing based on cellulose hydrate with nanoparticles

(76) Inventors: Martina KOENIG, Wiesbaden (DE); Volker Effern, Heidenrod-Kemel (DE); Susanne Redmann-Schmid, Mainz (DE); Walter Lutz, Budenheim (DE)

Correspondence Address: PROPAT, L.L.C., 425-C SOUTH SHARON AMITY ROAD, CHARLOTTE, NC, 28211-2841, US

(21) Appl. No.: 11/953,149

(22) Filed: Dec. 10, 2007

(30) Foreign Application Priority Data
Dec. 13, 2006 (DE) 10 2006 058 635.2

(51) Int. Cl. A22C 13/00; D01D 5/24

(52) U.S. Cl. 428/34.8; 264/209.1

(57) ABSTRACT

This invention relates to a food casing based on cellulose hydrate that further includes nanoscale additives. The nanoparticles measure from 0.5 to 1000 nm in at least one dimension. The nanoparticles can have uniform distribution in the cellulose hydrate matrix, or be on the surface, or can have been concentrated in those regions of the casing that are in the vicinity of the surface. The invention moreover relates to a process for production of the food casing and to its use as synthetic sausage casing.

### CROSS-REFERENCE TO RELATED APPLICATIONS

This application claims priority to German Patent Application 10 2006 058 635.2 filed Dec. 13, 2006 which is hereby incorporated herein by reference in its entirety.

### FIELD OF THE INVENTION

This invention relates to a food casing based on cellulose hydrate, to a process for its production, and to its use as synthetic sausage casing.

### BACKGROUND OF THE INVENTION

Flat or tubular food casings based on cellulose hydrate are usually produced by the viscose process. In this process, an alkaline cellulose xanthogenate solution known as “viscose” or “viscose solution” is extruded through an annular die or slot die, is coagulated in acidic solution in the form of cellulose hydrate gel, and is regenerated to give cellulose hydrate. The properties of the food casing can be varied via alteration in the viscose composition and incorporation of additives. If the viscose is applied to one or both sides of a fiber paper shaped to give a tube, and coagulated, and the cellulose is regenerated, the product is fiber-reinforced cellulose casings, also termed “cellulose fiber skins”. Production of fiber-reinforced casings can likewise use a viscose to which additives have been admixed. Casings of this type are used in particular for air-ripened or mold-ripened long-life sausage, for example for salami. Coating of the cellulose hydrate casings with a polyvinylidene chloride dispersion can markedly increase the oxygen- and water-vapor-barrier effect. This method is used to produce the materials known as internally PVDC-coated cellulose fiber skins. They are particularly suitable for scalded-emulsion sausage or for cooked-meat sausage.

Food casings perform important tasks during the production, ripening and storage of sausage, and therefore have to have many different properties. A wide variety of properties is demanded in addition to adequate mechanical strength, heat resistance, sausage-emulsion adhesion, peelability, conformability, ease of processing, water-vapor permeability, etc., their priority depending on the respective application. Improvement in a particular property can sometimes impair another property. By way of example, the conformability and ease of processing of the casing are improved by secondary plasticizers, such as glycerol, glycol or polyglycol. The bonding of the secondary plasticizers to the cellulose hydrate is not covalent but merely uses intermolecular forces. When the casing is soaked prior to filling or during scalding or boiling of the sausage, they are almost completely dissolved out of the material. The consequence of this is shrinkage, compaction and embrittlement of the casing after drying of the sausage. The shrinkage can cause the internal pressure in the sausage to rise so far that it bursts. These phenomena are especially attributable to cellulose hydrate crystallization.

To reduce the tendency toward crystallization, “primary” plasticizers are often therefore added to the viscose solution, and these give permanent plasticization. Particular primary plasticizers used are compounds which react with the cellulose molecules, e.g. N—(C₉-C₂₄)-alkyl-N,N′,N-trishydroxymethylurea, or similar compounds with long aliphatic carbon chain. However, unreactive compounds are also used, e.g. di- and polyhydroxy compounds esterified with long-chain aliphatic monocarboxylic acids, alkylene-oxide-based polymers having at least one N-hydroxymethylcarbamate group, or alginic acid or alginates.

However, these methods give very little control of the water-permeability of the sausage casings. Low water-permeability of the cellulose casings is decisive for ripening behavior and mold growth for air-ripened and mold-ripened long-life sausage. Uniform ripening of long-life sausage requires slow release of water through the casing during the first few days.

However, fiber-reinforced cellulose casings generally exhibit high water-permeability of from about 90 to 110 l of water per square meter of casing in 24 hours at a pressure of 40 bar. Sausages produced therewith are therefore ripened in ripening rooms in which constant high relative humidity can be maintained. If humidity is too low, or varies, “dry edges” form on the sausage. This is caused by excessively rapid drying of the sausage-emulsion surface in the first few days of ripening. The dry edge inhibits further loss of water, and the interior of the sausage therefore remains too moist even after the usual ripening time.

In order to reduce water permeability, attempts have been made to compact the cellulose hydrate casing, for example via repeated drying of the casings or via incorporation of crosslinking agents, such as cyclic urea-methylol compounds.

The moisture balance of cellulose hydrate casings is a criterion for their quality: the casings are intended to have maximum water absorption, i.e. have a high swelling factor. To determine the swelling factor, the casing is steeped in water, and adherent water is removed by centrifuging at a particular rotation rate. The casing material is weighed and then completely dried and again weighed. The difference in weights, expressed in percent of the weight of the dry casing, gives the swelling factor. A swelling factor of 120% means therefore that a casing whose dry weight is 100 g absorbs 120 g of water. The intention is that the casings in turn release the water only slowly. The water permeability gives no information about the amount of water which can be absorbed or released. Permeation is merely a measure of the water permeability of the casing, whereas moisture balance characterizes water absorption and water-retention capability. A good moisture balance provides a problem-free drying process in which no embrittlement or overdrying of the casing occurs. Addition of alginic acid or its salts to the viscose solution can give a permanently plasticized sausage casing with an improved swelling factor. These sausage casings are successful even without glycerol as secondary plasticizer. Alginic acid or alginate loosens the structure of the cellulose hydrate, and the degree of compaction of the glycerol-free celluose hydrate is therefore highest when the concentration of alginic acid or of alginate is small, the minimum concentration being 5% by weight, based on the weight of the celluose. However, casings of this type are papery and crack when dry or at low moisture contents. This disadvantage can be reduced by increasing the concentration of alginic acid/alginate. However, this increases permeation, giving the sausages impaired ripening properties.

A sausage casing is moreover intended to be easy to peel. In the case of scalded-emulsion sausage, the adhesion of cellulose-hydrate-based sausage casings with non-impregnated inner surface is so high that they cannot be peeled without simultaneously damaging the surface of the sausage emulsion. In long-life sausage, on the other hand, their adhesion is so low that they separate from the surface of the sausage emulsion during the ripening process, and do not shrink with the product, and form creases under which gel can collect or mold can develop.

Casings for scalded-emulsion sausages are therefore prepared with internal release agents. Examples of materials used for these release preparations are chromium-fatty acid complexes, mixtures comprised of a lower alkylcellulose and of the dimer of a higher ketene, fluorinated, crosslinked polymers and mixtures comprised of lecithin and alginate, chitosan, and/or casein.

Materials that have been used as adhesive impregnating agent for long-life sausages are in particular gelatin, polyamine-polyamide-epichlorohydrin resins, and chitosan.

To prevent undesirable reaction of the adhesion component of the internal impregnating agent with the cellulose material of the casing, a natural oil, a synthetic triglyceride mixture with plant-derived fatty acids whose carbon chain length is in the range from 4 to 14 carbon atoms, a paraffin oil, and/or a silicone oil has been added to the impregnating agent. Alongside this, an emulsifier for the oil could also be present.

However, specific types of uncooked sausage, such as pepper salami which has a pepper/gelatin-layer coating, place particular requirements on the sausage casing. Uncooked sausages intended for sale in self-service shops are often provided with a second packaging of a foil, for reasons of hygiene. They can also have a—generally transparent—dip-coating. These coatings, for example comprised of polyvinyl alcohol, are applied to the sausages after their ripening has been completed. Known sausage casings equipped with adhesive impregnating agents exhibit excessive adhesion to the sausage emulsion after the dipping process, while the casings equipped with separating preparations separate even before ripening is complete. One of the effects of the second packaging or the dip-coating is to alter the water balance of the sausage, and this affects the adhesion between sausage-emulsion surface and casing.

The cellulose-hydrate-based food casings hitherto available in the market do not satisfy all of the requirements placed upon them. Numerous efforts of producers of cellulose casings have quite often succeeded in improving one property only at the cost of impairment of another property.

Attempts have now been made to utilize nanotechnology for food packaging. The use of nanoparticles in the production of casings permits particular reinforcement of desired properties. However, these particles have hitherto been used only in connection with plastics casings or in application sectors outside the food industry (e.g. in the clothing industry or pharmaceutical industry).

For example, DE-A 103 44 449 discloses an adhesive composition which comprises a compound having at least one NCO group and having at least one radiation-curable reactive functional group, as component (A), and also a nanoscale filler, as component (B). This is used for adhesion between the individual sublayers of composite foils with barrier properties with respect to CO₂, O₂, N₂, water vapor, and flavors.

DE-A 10 2004 038 274 uses a nanoscale filler, preferably selected from the group of oxides, nitrides, halides, sulfides, carbides, tellurides, and selenides of the second to fourth main group, of the transition elements, of the lanthanides, and/or from the group of the polyorganosiloxanes, in a radiation-curable binder. This binder is likewise used in the production of composite foils with barrier properties.

EP-A 0 658 310 discloses an at least 4-layer coextruded, biaxially oriented, transparent, tubular sausage casing with a high level of barrier action with respect to water-vapor permeation and to oxygen permeation, and permeability to light. The barrier action with respect to water vapor is generated via at least one layer with polyolefinic character, and the oxygen-barrier action is generated via at least one layer which comprises ethylene/vinyl alcohol copolymers as essential constituent. One layer of the co-extruded composite also comprises very finely divided, inorganic pigments whose average grain size is from 0.01 to 5 micrometers, in an amount of up to 3% by weight, based on the total weight of the casing. This very fine pigment can, for example, be inorganic pigments comprised of zinc oxide, titanium dioxide, iron oxide, or silicon dioxide. When the casing is produced the pigment is, for example, introduced in the form of masterbatch. The carrier material in the masterbatch here is selected in such a way as to be compatible with the parent material of the layer. If particle size is less than 5 μm, there is hardly any effect on the transparency of the casing. This type of casing transmits less light, and this results in less graying of the sausage surface. However, no reduction in oxygen permeability through addition of the very fine pigments was found. The oxygen barrier generated with the aid of the EVOH-containing layer is moreover known to be highly moisture-dependent. The relationship between oxygen diffusion and relative humidity is known for various polymers in packaging using plastics. For example, oxygen diffusion for EVOH increases at 30° C. from 0.15 cm²·25 μm/m²·d·bar at 30% rel. humidity to 1.5 cm²·25 μm/m²·d bar at 75% rel. humidity.

WO 2002/000026 A1 relates to a single- or multilayer, biaxially oriented plastics skin with at least one layer which is comprised of polyamide and, where appropriate, of polyolefins, which comprises from 0.1 to 4% by weight of nanodisperse additives. These additives are in particular phyllosilicates, which can also have been organically modified. The thickness of the particles is preferably less than 10 nm. When compared with comparable plastics without nanodisperse additives, this plastics skin features improved barrier action with respect to oxygen, with unchanged high transparency.

U.S. Pat. No. 6,811,599 discloses a thermoplastic material which comprises, as essential constituents, natural polymers, plasticizers, and clay mineral, such as montmorillonite. The natural polymer here can be a polysaccharide or protein; in particular, starch, cellulose, chitosan, alginic acid, inulin, pectin, casein, and their derivatives are suitable. The clay material has a layer-type structure and has cation-exchange capacity of from 30 to 250 milliequivalents per 100 g of its weight. The clay material is present in dissolved form in the thermoplastic material, with substantial separation between the structure-forming layers. The proportion of the clay mineral in the thermoplastic material is from 0.1 to 90% by weight. Plasticizers proposed comprise water, glycerol, glycol, and also glycol oligomers, or a combination of these substances. The thermoplastic material based on potato starch, glycerol, water and clay mineral exhibits improved retention capability for water, with a resultant significant delay in the embrittlement which occurs after a short time with the known thermoplastic materials based on natural sources.

US-A 2005/0051054 describes a material which includes nanocomposites comprised of cellulose and clay mineral, where the proportion of the clay mineral is from 0.5 to 25% by weight, preferably from 5 to 15% by weight, and in particular from 7 to 10% by weight of the nanocomposites. The cellulose used in the material is obtained from chaff, wood, leaves, grass, bagasse, cotton, or wastepaper. Clay minerals used comprise by way of example hectorites or montmorillonite. The nano-composite material has considerably improved heat resistance when compared with conventional cellulose, for example derived from cotton.

EP-B 0 598 836 (=U.S. Pat. No. 5,747,560) discloses a polymer nanocomposite with lamellar particles whose thickness is in the region of a few nanometers. The intention is to use these materials with conventional foil-extrusion technology to produce foils whose thickness is in particular in the range from 25 to 75 μm. The foils here can be “stretch” foils, for example by way of a blown-film process.

EP-A 0 358 415 C (=U.S. Pat. No. 5,248,720) describers a molding composition comprised of a polyamide resin with a phyllosilicate uniformly dispersed therein. The thicknesses of the individual layers of the phyllosilicate are around 1 nm and the lengths of their sides are up to 1 μm. This material comprised of nylon-6 as base polymer can be used to produce moldings, among which are oriented foils, with a significant increase in level of oxygen barrier.

Consumers of meat products and of sausage products prefer products which remain fresh over a long period and retain their taste, nutritional value, and appearance. The products are also intended to be easy to prepare for consumption, and suitability for cooking, frying, or grilling, and peelability, are important here. Finally, producers of meat products and of sausage products demand that the food casings used for production of the products have good processability.

These varied requirements are only partially met by the food casings known in the prior art based on cellulose hydrate.

### SUMMARY OF ADVANTAGEOUS EMBODIMENTS OF THE INVENTION

The object of the present invention is to provide a food casing which is based on cellulose hydrate and whose properties meet the requirements of the market more effectively than can be achieved by the prior art. In particular, the intention is that the inventive food casing meets the following requirements:
high mechanical strength, in particular during stuffing,
resistance to hot or boiling water,
elastic shrinkage behavior so that it does not separate from the food even after prolonged storage,
resistance to cellulytic enzymes, such as those that can form from edible molds under unfavorable conditions,
if appropriate, bactericidal action, and also
if appropriate, crosslinkability on exposure to an alternating magnetic field.

### DETAILED DESCRIPTION OF ADVANTAGEOUS EMBODIMENTS OF THE INVENTION

These objects are achieved via a food casing based on cellulose hydrate, which comprises nanoscale additives. These can have been incorporated into the cellulose hydrate matrix and/or can have been applied in the form of impregnating agent or coating to the casing.

The expression “nanoscale additives” generally includes substances which take the form of nanoparticles measuring from less than 1 nm up to 1000 nm in at least one dimension. The particular functionality or action of nanoparticles under the nanoscale additives is based firstly on their large specific surface area, where the specific surface area is the ratio of surface area to weight (e.g. m²/kg) or of surface area to volume e.g. m⁻¹). Nanoparticles can moreover have chemical properties which differ markedly from the properties of a solid with the same chemical constitution and macroscopic dimensions. The particular chemical properties of nanoparticles here are a consequence of their modified electronic structure. The nanoparticles can be produced by two fundamentally different processes. In one of these, the particles are produced via aggregation of substances in dissolved, liquid, or gaseous molecular form (condensation method or bottom-up process). In the other, coarser particles are milled to give nanoparticles, for example in a stirred ball mill operating under wet conditions (dispersion method or top-down process). Nanoparticles produced by the bottom-up process often have a marked degree of agglgomeration. The mixing of these nanoparticles with the viscose therefore advantageously takes place in dissolvers or mixers which break up the agglomerates and disperse the individual particles thus released. Suitable dissolvers and mixers are known and are commercially available, for example from Netzsch Feinmahltechnik GmbH, D-95100 Selb.

The nanoscale additives of the present invention are comprised of organic or inorganic nanoparticles which measure from 0.5 to 1000 nm in at least one dimension. Additives comprised of organic/inorganic nanocomposite particles are moreover used. The proportion of the nanoscale additives, based on the total weight of the food casing, is from 0.5 to 50% by weight, preferably from 1 to 20% by weight, and in particular front 2 to 6% by weight.

In one preferred embodiment of the invention, the food casing is comprised of a matrix layer based on cellulose hydrate, the nanoscale additives having been dispersed in this layer. In two further embodiments of the invention, the inner or outer side of the food casing has a coating comprising nanoscale additives.

The nanoscale additives have preferably been selected from the group of:
phyllosilicates, in particular montmorillonite;
spherosilicates, in particular polyhedric oligo-hydrosilsesquioxane and polyhedric oligosilsesquioxane (POSS);
titanium dioxide (TiO₂);
silver or silver compounds; and
composites which encompass a ferromagnetic, ferrimagnetic, superparamagnetic, or paramagnetic core, and a casing comprised of thermally crosslinkable polymeric components.

The nanoscale additive ran generally also be an oxide, nitride, carbide, or halide of an element of the 2nd to 4th main group of the periodic table of the elements. Other suitable additives, besides nanoscale montmorillonite, are magnesium silicate and aluminum silicate, magnesium oxide, aluminum oxide, iron oxide, and manganese oxide, magnesium fluoride, lithium titanate, barium titanate, and nickel titanate, bayerite, kaolinite, calcium hydroxyapatite, calcium carbonate, bentonite, boehmite, hydrotalcite, hectorite, vermiculite, stevensite, saponite, diaspore, or mica, or a combination thereof.

For production of the inventive food casing, the nanoscale additive is mixed with viscose and the resultant mixture is extruded through a die and regenerated or precipitated. In an alternative embodiment, the nanoscale additive is mixed with a cellulose solution, for example a cellulose which has been dissolved in an optionally hydrous amine oxide, such as N-methylmorpholine N-oxide monohydrate. This solution is then extruded—if appropriate onto a support material—and then precipitated in a precipitation bath. In this embodiment, the cellulose is not chemically modified.

Impregnation or coating with nanoscale particles can take place on the inner and/or outer side of the food casing based on cellulose hydrate. The coating or impregnation is carried out by conventional processes known to the person skilled in the art. The present invention also encompasses those casings which comprise nanoscale particles homogeneously distributed in the cellulose hydrate matrix, or else comprise these particles in the form of a coating or impregnating agent. A coating or impregnating agent is recognizable in that the location of the particles is exclusively on the (outer and/or inner) surface of the casing, or there is a concentration of the particles in those regions of the casing in the vicinity of the surface. The particles in the matrix can be identical with those in the coating or impregnating agent, or else different. In particular for coatings or impregnating agents, it is preferable to use nanoscale particles which can interact with the cellulose hydrate, either via ionic bonds or via covalent bonds, via hydrogen bonds, or in another way, so that leaching of the particles during further processing of the casing is unlikely or impossible. By way of example, the POSS mentioned below can form covalent bonds. The nanoscale particles in the impregnating agents or coatings can have been combined with other constituents, such as binders (e.g. proteins, polysaccharides, or derivatives thereof), flavors and/or dyes (e.g. liquid smoke), known adhesive agents or known release agents, fungicides, pigments, etc.

One specific embodiment of the invention relates to food casings based on cellulose with reduced permeability to water and oxygen. For this, nanoscale phyllosilicates, such as montmorillonite, are added to the cellulose (or to the viscose solution). The phyllosilicate particles practically uniformly dispersed in the finished sausage casing inhibit diffusion or lengthen the diffusion path for water molecules and oxygen molecules through the substantially “open” network of the cellulose molecules/crystals.

Another advantageous embodiment of the invention is oriented toward a food casing which is resistant to the cellulases formed from edible mold. For this, the nanoscale additives used comprise polyhedric oligosilsesquioxanes (POSS), and the POSS molecules here have functionalization with organic groups (R).

Preference is given to polyhedric oligosilsesquioxanes (POSS) in which R has been selected from the group of the organic groups having from 1 to 30 carbon atoms, and R is in particular a group selected from phenyl, isooctyl, cyclohexyl, cyclopentyl, isobutyl, methyl, trifluoropropyl, and phenethyl.

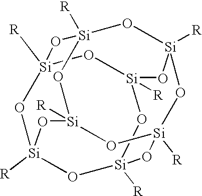

A POSS in which R is an alkyl moiety having an epoxy end group has proven particularly suitable, an example being

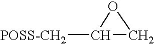

The epoxy end groups can produce covalent bonding of the POSS with the cellulose molecules. Very surprisingly, it has been found that even a small admixture of POSS in the region of 2% by weight noticeably improves the resistance of the sausage casing with respect to the cellulases formed from molds under unfavorable ripening conditions. The high efficiency is based inter alia on the excellent solubility of the POSS nanoparticles and the fact that they exhibit practically no agglomeration.

Another embodiment of the invention provides a cellulose-fiber skin which comprises nanoscale additives. During its production, a sheet-like fiber material with wet strength, for example a hemp-fiber paper, is shaped to give a tube with overlapping longitudinal edges. This tube is then passed through a coating die and treated with viscose from inside, from outside, or from both sides. This method can be used to obtain “externally viscosed”, “internally viscosed”, or “double-viscosed” cellulose-fiber skins. The nanoscale additives can accordingly be mixed with the viscose applied from the outside or the viscose applied from the inside. They can also, if appropriate, have been mixed with the viscose applied from the outside and with the viscose applied from the inside. Coagulation and regeneration of the cellulose takes place in the conventional way in acidic precipitation baths and acidic regeneration baths. The fiber skin is then, again in the conventional way, passed through a number of wash baths, and also, if appropriate, through a plasticizer bath. The plasticizer used generally comprises glycerol, which is applied in the form of an aqueous glycerol solution. The nanoscale additives have no adverse effect on these steps of the process. There is practically no leaching of these additives from the cellulose hydrate matrix.

One particularly preferred embodiment of the invention provides a food casing resistant to bacterial infestations. For this, nanoparticles comprised of titanium dioxide, silver, or silver compounds are in particular used. The bactericidal action of titanium dioxide nanoparticles is based on a photocatalytic effect. By virtue of the electronic structure of titanium dioxide, electrons can be excited by UV light. This process leads, in the presence of water and oxygen, to formation of highly reactive hydroxyl (.OH) and perhydroxyl radicals (HOO.), which destroy microorganisms located at the surface of the particles. They therefore exhibit a toxic action with respect to bacteria, yeasts, and fungi. Alongside titanium dioxide, tin oxides and zinc oxides also exhibit photocatalytic properties, but titanium dioxide is the photocatalyst most often used here.

It is preferable to use titanium dioxide particles whose diameter is less than 100 nm, because nanoscale particles have a more marked photocatalytic effect and the particles are moreover transparent, since their diameter is smaller than the wavelength of visible light. Examples of bactericidal titanium dioxide nanoparticles suitable for the purposes of the present invention are obtainable as NANOZID® from ItN Nanovation GmbH.

In another embodiment, silver-containing nanoparticles are used. The increasing number of bacterial strains resistant to antibiotics has reawakened interest in silver as antibiotic. The bactericidal action here arises from silver ions. Silver ions block enzymes which are necessary for oxygen metabolism of cells, thus suppressing central metabolism functions of cells. Silver ions moreover destabilize the cell membrane and disrupt cell division and therefore disrupt multiplication of bacteria. On the basis of these specific mechanisms of action, it is assumed that bacteria cannot develop resistance to silver. Use of nanoparticles enlarges the silver surface area in contact with the environment; the amount of silver needed for the same bactericidal effect is moreover substantially smaller.

Another advantage of silver nanoparticles is that they serve as silver depots which continuously release silver ions, thus giving long-term disinfection. They migrate to the surface of the polymer in the polymer matrix, and even a small proportion of silver nanoparticles is therefore adequate for antimicrobial action. Newly developed production processes moreover permit production of silver nanoparticles whose diameter is only about 5 nm. It has been found here that antimicrobial activity becomes higher as the diameter of the particles becomes smaller.

The present invention also provides a “switchable” food casing whose properties, e.g. permeability to oxygen and water vapor, can be modified via external action of initiators, heat, UV light, and the like. This type of switchable food casing is suitable for foods which after packaging first undergo a ripening process, where substances are exchanged with the environment, an example being water-vapor dissipation. After conclusion of the ripening process, the intention is to suppress exchange of substances in order, for example, to avoid excess drying. Accordingly, there is a demand for capability for controlled switch-on or -off of permeability or of other properties of the food casing.

In another embodiment of the present invention, a food casing based on cellulose hydrate is equipped with magnetic nanoparticles or, respectively, nanocomposites, e.g. MAGSILICA® from Degussa AG, and with a thermally crosslinkable polymeric component. The magnetic nanoparticles are caused to vibrate or rotate by means of a high-frequency alternating magnetic field. By virtue of the friction losses in the food casing surrounding the magnetic nanoparticles, mechanical energy is converted to thermal energy, and the food casing therefore becomes hot and the polymeric component crosslinks. It has proven particularly advantageous here that localized heating takes place in the food casing and that the product packaged in the food casing is subjected to practically no thermal or other effects, e.g. UV light. As a function of the chemical constitution of the thermally crosslinked polymeric component, and its quantitative proportion and spatial distribution, in the cellulose hydrate matrix, the permeability of the food casing to water vapor and/or oxygen is “switched off” or, respectively, reduced in a controlled manner. It is preferable to use nanoparticles in which the magnetic core has been embedded into a chemically inert shell.

The inventive casing can also comprise the primary and/or secondary plasticizers described in the introduction. It can moreover have been impregnated or coated on the inner side and/or outer side, for example using an inner coating based on polyvinylidene chloride or on vinylidene chloride copolymers.

The inventive food casing is preferably used for the packaging of meat products and of sausage products, in particular in the form of synthetic sausage casing.

The examples below serve to illustrate the invention. Percentages in the examples are percentages by weight unless otherwise stated or directly discernible from the context.

### Example 1

A tubular colorless sausage casing, caliber 60°, was produced by the known viscose process—in the present case by means of a fiber S cellulose solution in CS₂/NaOH—where 2 or 2.5% of “PGN Polymer Grade Montmorillonites” nanoscale phyllosilicate from Nanrocor, in each case based on the weight of the cellulose, was admixed with the stream of viscose. The viscose mixture was conventionally extruded and regenerated, and the resultant casing was then dried. A casing without addition of nanoparticles was used for comparative purposes.

The following individual values were measured:

| | | | 2% by | 2.5% by |
|---|---|---|---|---|
| Nanoscale phyllosilicate | | without | weight | weight |
| WVD [g/m² d] | | 900 | 760 | 860 |
| Water permeation [l/m² d] | | 100 | 118 | 92 |
| Surface tension [mN/m] | | 44 | 35 | 35 |
| Peelability | | satisfactory | good | good to |
| | | | | very good |
| Ultimate tensile | longitudinal | 31 | 29 | 31 |
| strength | transverse | 29 | 30 | 28 |

### Example 2

The inner side of a colorless cellulose-fiber skin (fiber N from Kalle GmbH) whose diameter was 55 mm (=caliber 55) was impregnated with a 5% strength aqueous solution of the nanoscale phyllosilicate mentioned in example 1. This reduced water permeation from 100 l/m²·d in the non-impregnated condition to 82 l/m²·d.

That which is claimed:

1. A food casing based on cellulose hydrate comprising nanoscale additives.

2. The food casing as claimed in claim 1, wherein the nanoscale additives are nanoscale particles having uniform distribution in a matrix formed by the cellulose hydrate.

3. The food casing as claimed in claim 1, wherein the nanoscale additives are nanoscale particles (i) on the surface of the casing or (ii) concentrated in regions of the casing in the vicinity of the surface.

4. The food casing as claimed in claim 1, wherein the nanoscale additives comprise nanoparticles that measure from 0.5 to 1000 nm in at least one dimension.

5. The food casing as claimed in claim 1, wherein the nanoscale additives comprise organic or inorganic nanoparticles.

6. The food casing as claimed in claim 1, wherein the nanoscale additives comprise organic/inorganic nanocomposite particles.

7. The food casing as claimed in claim 1, wherein the proportion of nanoscale additives, based on the total weight of the food casing, is from 0.5 to 50% by weight.

8. The food casing as claimed in claim 1, said food casing comprising a fiber reinforcement.

9. The food casing as claimed in claim 8, wherein an inner and/or outer side of the fiber reinforcement has a layer comprising cellulose hydrate, and the nanoscale additives are nanoscale particles distributed in one or both of the cellulose hydrate layers.

10. The food casing as claimed in claim 1, wherein the nanoscale additive is a phyllosilicate, a spherosilicate, or a titanium dioxide (TiO₂).

11. The food casing as claimed in claim 1, wherein the nanoscale additive comprises silver or a silver compound.

12. The food casing as claimed in claim 1, wherein the nanoscale additive comprises composite particles having a ferromagnetic, ferrimagnetic, superparamagnetic, or paramagnetic core, and the food casing comprises a thermally crosslinkable polymeric component.

13. A process for producing a food casing based on cellulose hydrate as claimed in claim 1 comprising mixing at least one nanoscale additive with a viscose solution or a cellulose solution and extruding the mixture through a die and regenerating or precipitating the viscose solution or cellulose solution and/or applying, to the inner side and/or outer side of the food casing an impregnating agent or a coating comprising nanoscale additives.

14. Synthetic sausage casing comprising food casing as claimed in claim 1.

15. The food casing as claimed in claim 11, wherein the proportion of nanoscale additives, based on the total weight of the food casing, is from 1 to 20% by weight.

16. The food casing as claimed in claim 1, wherein the proportion of nanoscale additives, based on the total weight of the food casing, is from 2 to 6% by weight.

17. The food casing as claimed in claim 1, said food casing comprising a flat fiber material.

18. The food casing as claimed in claim 1, said food casing comprising a hemp-fiber paper with wet strength.

19. The food casing as claimed in claim 1, wherein the nanoscale additive is a montmorillonite or a polyhedric oligohydrosilsesquioxane.

20. Uncooked-sausage synthetic casing comprising food casing as claimed in claim 1.
